(19) United States
(12) Patent Application Publication
(10) Pub. No.: US 2013/0325496 A1
(43) Pub. Date: Dec. 5, 2013

(54) SYSTEM FOR PREVENTING FRAUD

(71) Applicant: Vincent Nasso, Malverne, NY (US)

(72) Inventor: Vincent Nasso, Malverne, NY (US)

(21) Appl. No.: 13/908,337

(22) Filed: Jun. 3, 2013

Related U.S. Application Data
(60) Provisional application No. 61/654,454, filed on Jun. 1, 2012.

(51) Int. Cl. G06Q 10/08; G06Q 50/22

(52) U.S. Cl. CPC G06Q 10/08; G06Q 50/22
USPC 705/2

(57) ABSTRACT

A system for preventing fraud may be provided. The system may include a processor that may receive a prescription for a patient from a physician that is registered with the system. Additionally, the processor may be configured to receive a patient identification number, a financial identification number, and a group identification number from a digital prescription provided by the patient when the patient attempts to fill the prescription. If the patient identification number, the financial identification number, and the group identification number from the digital prescription match the information in the prescription received from the physician, then the processor may transmit a signal to enable the patient to receive medicine associated with the prescription. However, if the patient identification number, the financial identification number, and the group identification number from the digital prescription do not match the prescription from the physician, the processor may prevent the patient from receiving medicine.

### CROSS REFERENCE TO RELATED APPLICATIONS AND PRIORITY

The present application claims priority to U.S. Provisional Application No. 61/654,454, filed Jun. 1, 2012, the entirety of which is hereby incorporated by reference.

### FIELD OF THE INVENTION

The present application relates to fraud prevention systems and methods, and more particularly to a system for preventing fraud.

### BACKGROUND

As recreational drug use and drug addiction have risen in recent years, prescription fraud, particularly by those seeking to use and distribute prescription drugs, has risen dramatically. Prescription fraud typically involves the wrongful gain of prescription drugs for profit or for personal use without a valid prescription from a physician. Patients, physicians, pharmacies, and others perpetrate prescription fraud in a variety of ways. For example, patients may illegally obtain a valid prescription pad and write fraudulent prescriptions, alter a physician's prescription by increasing the amount of the drug to be administered, preparing a falsified prescription by using a fictitious physician's name, forging a prescription from a valid practicing physician, and calling in their own prescription and using their own telephone number as a callback number. Also, physicians may also commit prescription fraud by accepting inappropriate fees from drug manufacturers to dispense a particular drug, engaging in pricing fraud by prescribing patients expensive drugs that a patient may or may not need, billing insurers for fraudulent prescriptions, receiving kickbacks for writing fraudulent prescription, and committing other fraudulent activities.

In addition to fraud perpetrated by patients and physicians, pharmacies may also commit fraud by billing for brand name drugs when generics are actually dispensed, billing for non-existent prescriptions, billing for multiple payers for the same prescription, billing for prescriptions that are filled but never actually picked up, billing for splitting prescriptions into a smaller day's supply to increase dispensing fees, or offering or accepting kickbacks. Also, pharmacies often engage in drug shorting by providing less that the quantity prescribed by the physician and then billing the insurance provider for the full amount detailed in the prescription. Furthermore, pharmacies may also pay physicians to persuade a patient to go to a particular pharmacy or may even dispense an inaccurate number of refills for a patient. Although many pharmacies, physicians, or other individuals have instituted procedures and rules to help combat and thwart prescription fraud, such procedures and rules are often easily exploited or circumvented by those willing to engage in prescription fraud.

### SUMMARY

In accordance with one aspect of the exemplary embodiments provided herein, a system for preventing fraud may be provided. The system may include a memory that stores instructions, and a processor that executes the instructions to perform various operations of the system. One operation of the system may include receiving a prescription for a patient from a physician registered with the system. The prescription may include a first patient identification number, a first financial identification number, and a first group identification number of a patient associated with the prescription. Another operation of the system may include receiving a second patient identification number, a second financial identification number, and a second group identification number from a digital prescription of the patient when the patient attempts to fill the prescription. The system may further include an operation that includes allowing medicine associated with the prescription to be given to the patient if the first the first patient identification number, the first financial identification number, and the first group identification number of the prescription match the second patient identification number, the second financial identification number, and the second group identification number from the digital prescription of the patient.

According to another embodiment, a method for preventing fraud may be provided. The method may include utilizing a memory that stores instructions, and a processor that executes the instructions to perform the various steps of the method. The method may include receiving a prescription for a patient from an authorized physician, wherein the prescription is received by the processor of a system. Additionally, the method may include receiving a patient identification number, a financial identification number, and a group identification number from a digital prescription of the patient when the patient attempts to fill the prescription. Furthermore, the method may include determining if the patient identification number, the financial identification number, and the group identification number from the digital prescription match the prescription received for the patient by utilizing the processor of the system. Moreover, the method may include transmitting a signal to allow the patient to receive medicine associated with the prescription if the patient identification number, the financial identification number, and the group identification number from the digital prescription are determined to match the prescription for the patient from the authorized physician.

According to another embodiment, another system for prevent fraud may be provided. The system may include a memory that stores instructions, and a processor that executes the instructions to perform various operations of the system. One operation of the system may include receiving a prescription for a patient from a physician registered with the system. Another operation of the system may include receiving a patient identification number, a financial identification number, and a group identification number from a digital prescription of the patient when the patient attempts to fill the prescription. A further operation of the system may include determining if the patient identification number, the financial identification number, and the group identification number from the digital prescription match the prescription received for the patient from the physician. The system may also include an operation including transmitting a signal to enable the patient to receive medicine associated with the prescription if the patient identification number, the financial identification number, and the group identification number from the digital prescription are determined to match the prescription for the patient from the physician.

In accordance with another embodiment, a system for preventing fraud may be provided. The system may include a processor that may be configured to receive a prescription for a patient from a physician registered with the system. The prescription may include information such as a first patient identification number, a first financial identification number, and a first group identification number of a patient associated with the prescription. The processor may also be configured to receive a second patient identification number, a second financial identification number, and a second group identification number from a card of the patient when the patient attempts to fill the prescription. Furthermore, the electronic processor may be configured to allow medicine associated with the prescription to be given to the patient if the first patient identification number, the first financial identification number, and the first group identification number of the prescription match the second patient identification number, the second financial identification number, and the second group identification number from the card of the patient.

In accordance with another exemplary embodiment, a method for preventing fraud may be provided, which can include, but is not limited to including, the steps of: receiving a prescription for a patient from an authorized physician, wherein the prescription is received by a processor of a system; receiving a patient identification number, a financial identification number, and a group identification number from a card of the patient when the patient attempts to fill the prescription; determining if the patient identification number, the financial identification number, and the group identification number from the card match the prescription received for the patient by utilizing the electronic processor of the system; and transmitting a signal to allow the patient to receive medicine associated with the prescription if the patient identification number, the financial identification number, and the group identification number from the card are determined to match the prescription.

In accordance with another exemplary embodiment, another system for preventing fraud may be provided. The system may include a processor that may be configured to receive a prescription for a patient from a physician registered with the system. Additionally, the processor may be configured to receive a patient identification number, a financial identification number, and a group identification number from a card of the patient when the patient attempts to fill the prescription. Furthermore, the processor may be configured to determine if the patient identification number, the financial identification number, and the group identification number from the card match the prescription received for the patient. Moreover, the processor may be configured to transmit a signal to enable the patient to receive medicine associated with the prescription if the patient identification number, the financial identification number, and the group identification number from the card are determined to match the prescription.

The above-described and other features and advantages of the present disclosure will be appreciated and understood by those skilled in the art from the following detailed description, drawings, and appended claims.

### BRIEF DESCRIPTION OF THE DRAWINGS

FIG. 1 illustrates a system for preventing fraud according to an embodiment of the present disclosure;

FIG. 2A illustrates a front view of an example secure card for use with the system of FIG. 1;

FIG. 2B illustrates a back view of the example secure card of FIG. 2A;

FIG. 3 illustrates a flow diagram for registering users to a system for preventing fraud;

FIG. 4A illustrates when a patient prescription is filled in a method for preventing fraud according to an embodiment of the present disclosure;

FIG. 4B illustrates when a patient prescription is not filled in the method of FIG. 4A according to an embodiment of the present disclosure;

FIG. 5 illustrates a system for preventing fraud that does not require the use of a secure card according to an embodiment of the present disclosure;

FIG. 6 illustrates an example patient form for inputting information associated with a patient into the systems of FIG. 1 or FIG. 5;

FIG. 7 illustrates an example doctor form for inputting information into the systems of FIG. 1 or FIG. 5;

FIG. 8 illustrates an example drug form for inputting information into the systems of FIG. 1 or FIG. 5;

FIG. 9 illustrates a method for preventing fraud according to an embodiment of the present disclosure;

FIG. 10 is a schematic diagram of a machine in the form of a computer system within which a set of instructions, when executed, may cause the machine to perform any one or more of the methodologies of the system for providing access to a distributed marketing platform.

### DETAILED DESCRIPTION OF THE INVENTION

The exemplary embodiments of the present disclosure are described with respect to systems and methods for preventing fraud and filling prescriptions. A system for preventing fraud according to the present disclosure may include an electronic processor for performing the operating functions therein. The system may be configured to receive a prescription from a physician for a particular patient. The physician may provide the patient with a secure card that may include a patient identification number, a financial identification number, a group identification number, and/or other information. After receiving the card, the patient may the proceed to a pharmacy to fill the prescription. At this point, a pharmacist or other qualified individual can receive the card from the patient. The electronic processor may then proceed to verify the information on the card against the prescription that is provided by the physician.

In an embodiment, the electronic processor may be configured to determine if the patient identification number, the financial identification number, and the group identification number from the card match the information in the prescription received for the patient. If the patient identification number, the financial identification number, and/or the group identification number from the card match the prescription, the electronic processor may transmit a signal to the pharmacy to enable the pharmacy to give the patient the medication prescribed in the prescription. However, if the information in the card does not match the information provided in the prescription or if the patient attempts to fill the prescription at an interval or dosage not prescribed by the physician, the electronic processor may transmit a signal to the pharmacy to prevent the medication from being given to the patient. In an embodiment, information associated with the patient, the card, the prescription, and any operative functions performed or executed by the system may be stored in databases for monitoring fraud or for other contemplated purposes disclosed in the present disclosure or otherwise. In another embodiment, the system does not need to utilize the card to verify the prescription for the patient. It should be understood by one of ordinary skill in the art that the exemplary embodiments of the present disclosure can be applied to other types of systems and methods, such as those described below. Additionally, features of the exemplary embodiments can be used with each other and/or with alternative features that are not shown.

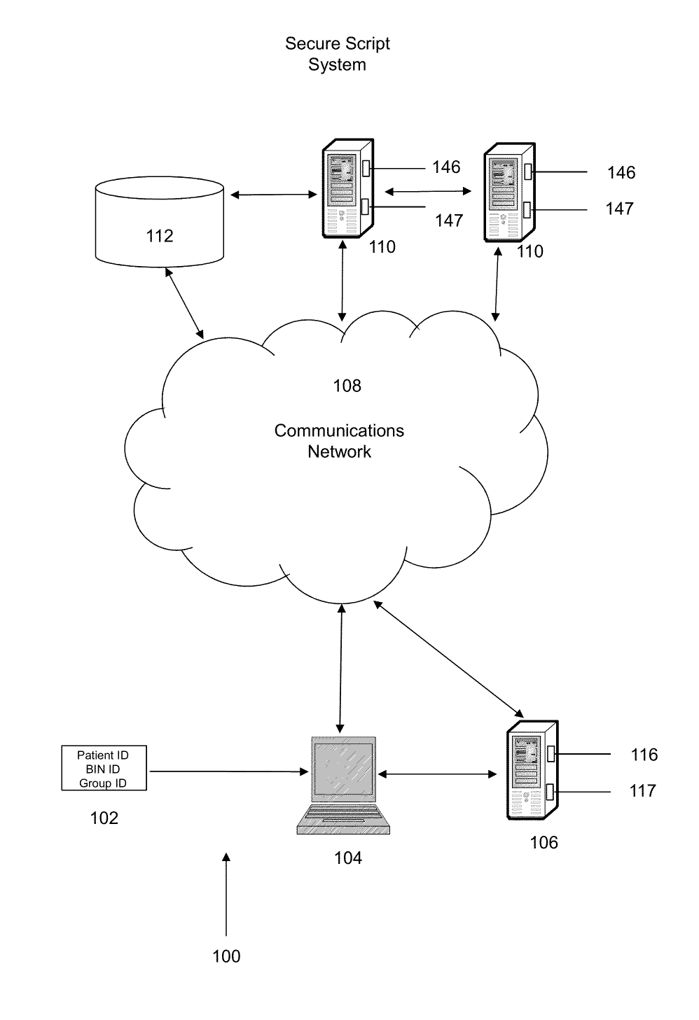

Referring to each of the drawings and in particular to FIG. 1, an embodiment of a system 100 for prevention of fraud, such as a secure script system, is schematically illustrated. The system 100 may include a card 102, a computing device 104, a server 106, a communications network 108, servers 110, and a database 112. The system 100 is illustratively shown to have a particular structure, however, other alternative structures, such as those described herein or otherwise, may also be utilized. Additionally, the system 100 may include each of the components described herein or a greater or fewer number of components and is not intended to be limited to the structure illustratively shown in FIG. 1. The system 100 may also include an electronic processor for performing a variety of the operative functions described herein. The electronic processor may reside in any of the components provided for in FIG. 1 or in another component.

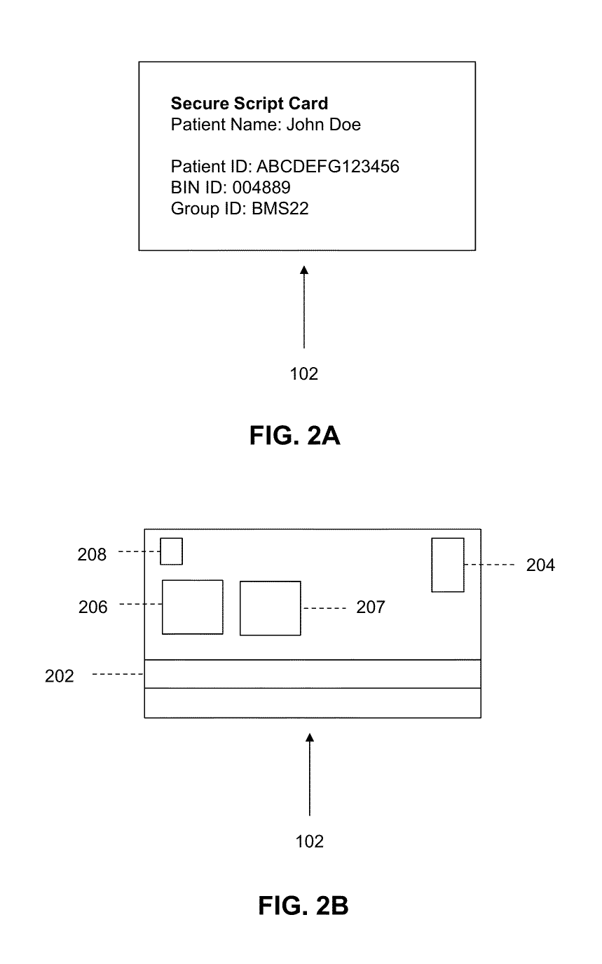

Referring now also to FIGS. 2A and 2B, the card 102 may be a secure card that may be given to a patient by a physician so that the patient may fill a prescription that the physician prescribes. In an embodiment, the card 102 may also be known as a secure script card. The card 102 may include, but is not limited to including, a patient name, a patient identification number, a financial identification number, and a group identification number. In an embodiment, the patient identification number may be utilized to uniquely identify a particular patient from another patient. For example, one patient may have a patient identification number of ABCDEFG123456 and another patient may have a patient identification number of ZXCVBNM654321. In an embodiment, the financial identification number may be utilized to identify a particular financial institution associated with the patient. For example, the financial identification number may be similar to a typical bank identification number (BIN) or routing number used with credit cards or products that utilize such numbers. In an embodiment, the group identification number may be utilized to uniquely identify a particular physician practitioner. In another embodiment, the group identification number may be similar to a group identification number found on typical insurance cards.

Optionally, the card 102 may include a storage medium 202, which may be utilized to store the patient name, the patient identification number, the financial identification number, the group identification number, or a combination thereof. The storage medium 202 may also be configured to store other information disclosed herein as well. In an embodiment, the storage medium 202 may be a magnetic strip, a barcode, a quick response code, or other similar type of storage medium and may be read by a device capable of reading such storage mediums. Additionally, the card 102 may optionally include a power source 204, such as a battery, that may be couplable to the components of the card 102 and may be utilized to power the components of the card 102. Furthermore, the card 102 may include a storage device 206, which may be similar to a computer memory or other memory device. The storage device 206 may be utilized to store the same information that the storage medium 202 stores, along with prescriptions or other patient-related information. In an embodiment, the storage device 206 may include an electronic processor 207 or may be electronically couplable to any electronic processor of the system 100 or other electronic processor. In an embodiment, the card 102 may include a radio frequency device 208, such as a radio frequency identification tag, that may be configured to store similar information as the storage device 206 and may be read by a reader or other similar device. In another embodiment, the card 102 may be configured to be able to make purchases, such as purchases for the medication associated with the prescription.

As described herein, the system may include a computing device 104. The computing device 104 may be a personal computer, mobile device, personal digital assistant, computer tablet, or other device that may include an electronic processor for performing the operative functions of the system 100 disclosed herein. The computing device 104 may be configured to receive a prescription, such as an electronic prescription, from a physician. The prescription may include, but is not limited to including, the financial identification number, the patient identification number, the group identification number, a name of the patient, an address of the patient, a date of birth of the patient, a date associated with the prescription, a name of the physician, a drug enforcement agency number, a national provider identifier number, and a quantity and course of medicine to be prescribed. In an embodiment, a pharmacist or other authorized personnel may review information on the card 102 and may input the information manually into the computing device 104 to determine if the patient is authorized to receive medication. In another embodiment, the pharmacist or other authorized personnel may use the computing device 104 to automatically read the information on the card 102. For example, if the card 102 has a magnetic strip, radio frequency identification tag, and/or other readable component, the pharmacist may have a reader or other device associated with the computing device 104 that may automatically retrieve the information from the card 102. The information from the card 102 that is either manually and/or automatically entered into the computing device 104 may be sent to a server 106 and/or a communications network 108 for handling, verification, and/or storage.

The server 106 may be a physical computer, computer program, or a combination thereof, that may be utilized to perform the operative functions disclosed herein. The server 106 may include a memory 116 that stores instructions and a processor 117 that executes the instructions from memory 116 to perform various operations for the server 106. In one embodiment, the server 106 may be configured to receive the information from the card 102 from the computing device 104 and may process the information. The server 106 may relay the information from the card 102, along with any other information disclosed herein, to a communications network 108. The communications network 108 may be a closed network, a virtual private network, the internet, or any other suitable network that may be utilized to connect to the devices in the system 100 to one another. The communications network 108 may transmit the information received from the computing device 104 and/or server 106 to servers 110 and/or database 112. The servers 110 may include memories 146 that store instructions and processors 147 that executes the instructions from the memories 146 to perform various operations for the servers 110. In an embodiment, the servers 110 may be configured to verify the information received from the card 102 against the prescription received from the physician. If the servers 110 determine that the information is verified, then the servers 110 may transmit a signal to the server 106 and/or the computing device 104 indicating that the patient may receive the medication indicated in the prescription. However, if the servers 110 do not verify the information from the card 102 with the prescription, the servers 110 can transmit a signal to the server 106 and/or the computing device 104 indicating that the patient may not receive the medication prescribed in the prescription. For example, if the servers 110 determine that the information from the card 102 does not match information in the prescription, then the servers 110 may transmit a signal to the server 106 that will provide an indication that the patient should not receive the medication he or she is attempting to obtain.

The database 112 of the system 100 may be configured to store and collect information for every information exchange occurring between the various devices and components of the system 100. In an embodiment, the database 112 may store the patient identification number, the financial identification number, the group identification number, the prescription, information relating to the verification of the information from the card 102 with the prescription, and any other information. The database 112 may also store information associated with manufacturers, wholesalers, pharmacies, physicians, patients such as, but not limited to, registration information, information related to medicine distributed by the manufacturers, wholesalers, and pharmacies, information related to whether a patient has triggered a fraud alert in the system 100, or any other information disclosed herein.

Operatively, the system for preventing fraud 100 may operate, in one embodiment, as follows: A patient may visit a physician for a medical checkup and the physician may determine that the patient needs a prescription for a particular medication. At this point, the physician may give the patient a card 102, which may also be known as a secure script card, that may include at least one of a patient identification number, a financial identification number, and a group identification number. In an embodiment, the identification numbers may be generated by the system 100 and the patient and physician may be registered with the system 100, such as via a graphical user interface of a website or other software application of the system 100. Once the physician gives the card 102 to the patient, the physician may then transmit a prescription, such as an electronic prescription, to a computing device 104 and/or server 106 of the system 100. In one embodiment, the physician may transmit the prescription via the website or other application of the system 100. In an embodiment, the computing device 104 and/or the server 106 may reside in a pharmacy that may be registered with the system 100. Additionally, the prescription may be transmitted to the wholesaler and/or the manufacturer of the medicine, each of which may be connected to and registered with the system 100.

The patient may then proceed to the pharmacy to fill his or her prescription. A pharmacist or other authorized individual may then take the card 102 from the patient and utilize the system 100 to verify the information on the card 102 against the prescription provided by the physician. In one embodiment, the system 100 may verify the information on the card 102 against the prescription by utilizing computing device 104, server 106, and servers 110. If the system 100 does not verify the information on the card 102 against the prescription, system 100 may transmit a signal to computing device 104, which may indicate that the patient is not allowed to receive the medication that the patient attempted to obtain. However, if the system 100 does verify the information on the card 102 against the prescription, the system 100 may transmit a signal to computing device 104, which may indicate that the patient may receive the medication he or she is attempting to obtain from the pharmacy.

All information associated with the card 102, the prescription, and the information exchange occurring between the patient and the pharmacist may be recorded in the database 112 and/or transmitted to all devices and entities in the system 100. For example, the information may be transmitted to physicians, wholesalers, manufacturers, government agencies, pharmacies, and other entities of the system 100. In an embodiment, if the information from the exchange indicates that the patient attempted to commit prescription fraud, the system 100 may generate a report and send the report to a government agency to investigate the matter. In another embodiment, if the information exchange verifies that the patient is authorized to the receive the medication, the computing device 104 or other device in the system 100 may transmit a signal to wholesalers and manufacturers to supply the pharmacy with medication to distribute to the patient. In yet another embodiment, if the patient is verified to receive the medication, the system 100 may generate an authorization number to allow for third party billing, and then the medication may be given to the patient.

Notably, features of the systems described herein can be combined or otherwise associated with the other systems and features described above and/or the methods described below.

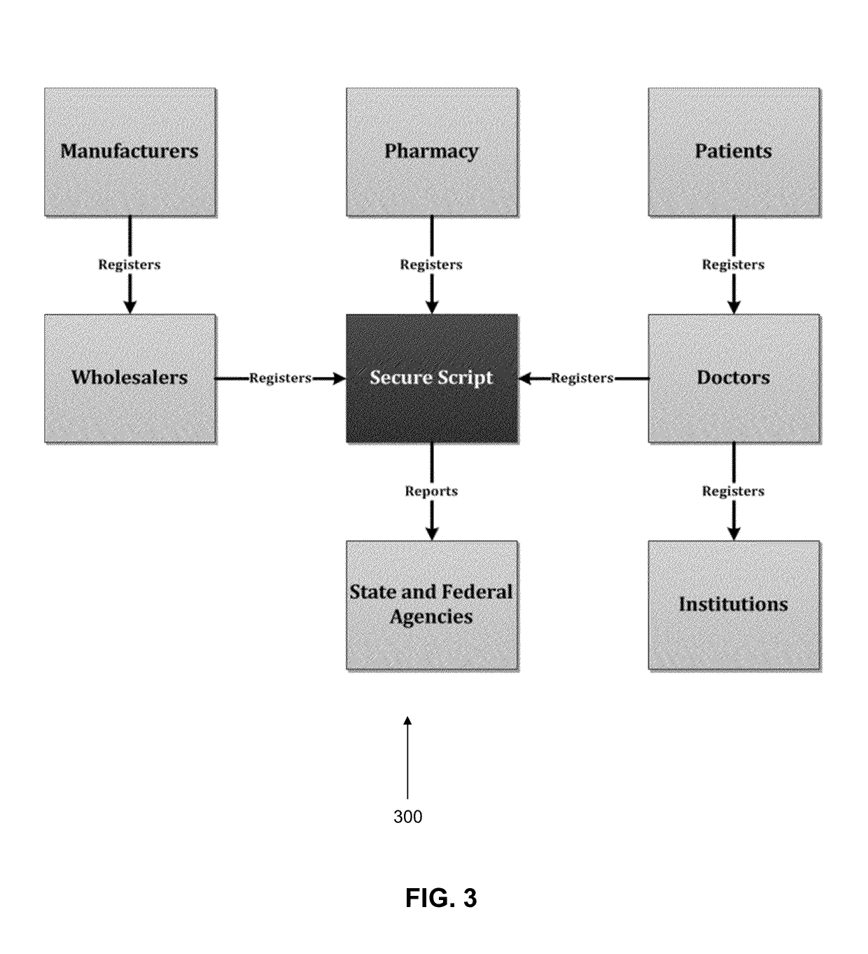

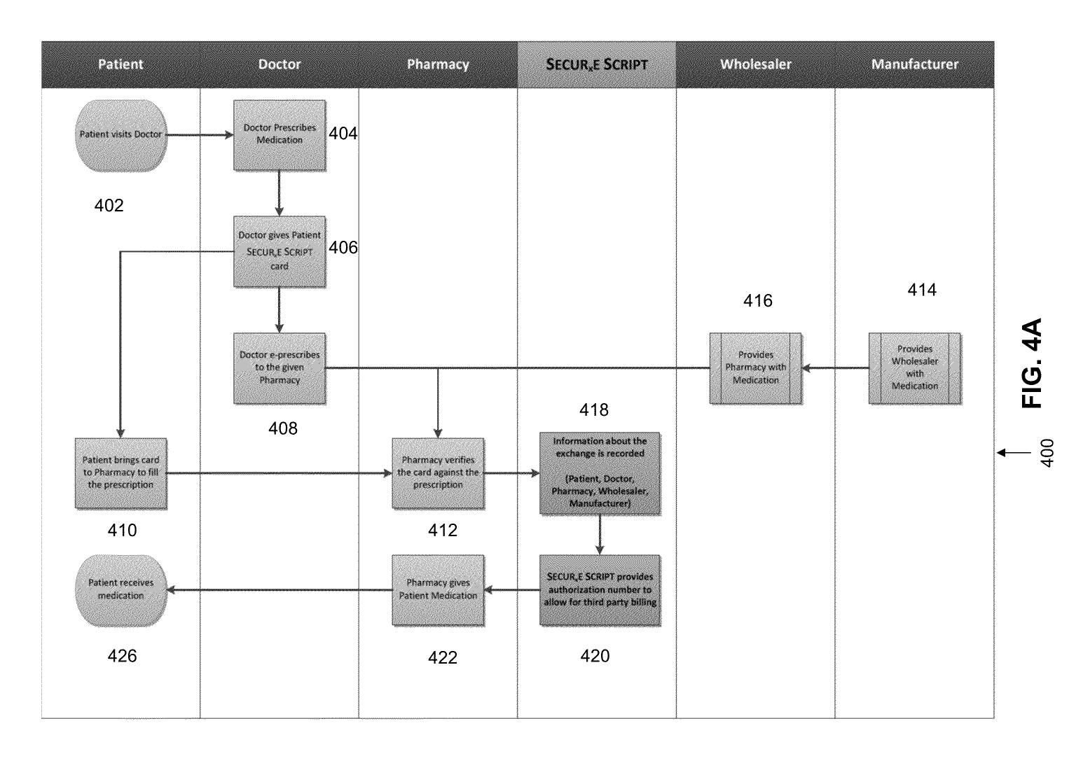

Referring now also to FIG. 3, an illustrative flow diagram 300 for registering users to the system 100 is schematically illustrated. The flow diagram 300 illustrates that manufacturers, wholesalers, pharmacies, patients, physicians/doctors, and institutions can each register with the system 100. Each of the entities that register with the system 100 may be given access to any information traversing the system 100 and the information may, in an embodiment, be restricted to only the entities in the system as well. The flow diagram 300 further illustrates that the system 100 may generate reports that may be sent to state and federal agencies as disclosed herein or otherwise.

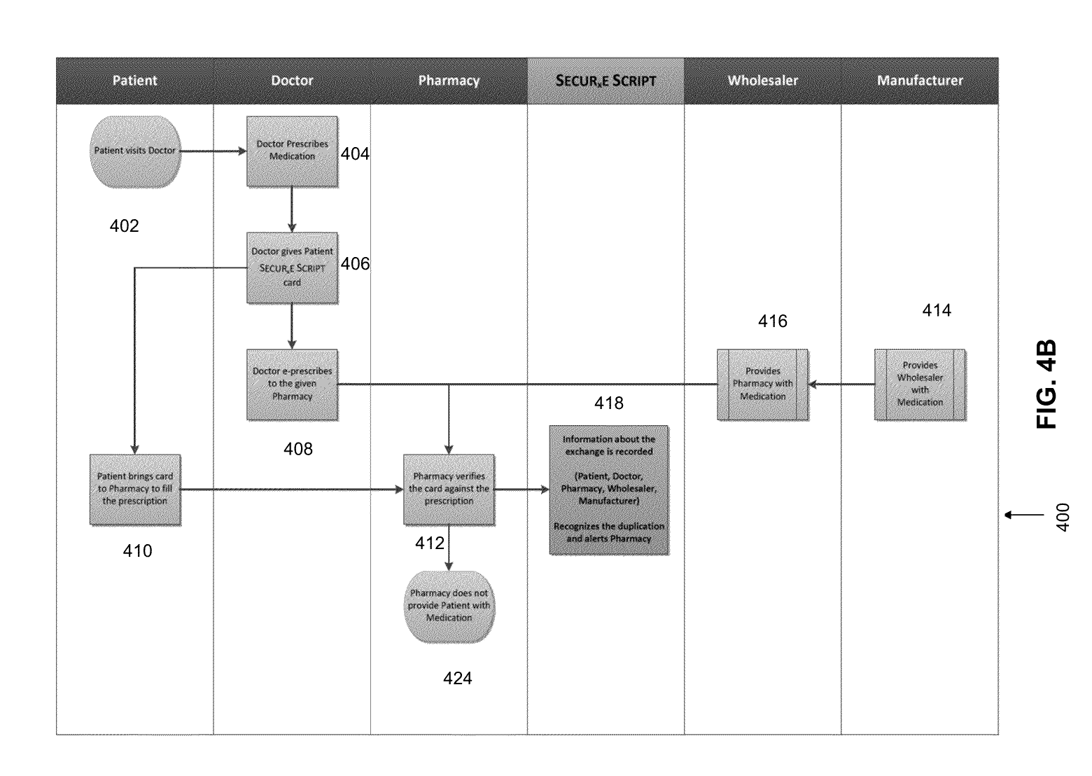

Referring now also to FIGS. 4A and 4B, an illustrative method 400 for preventing fraud is schematically provided. Notably, the method 400 is not intended to be limited to the systems, features, and components described above or illustrated in the drawings. The method 400 may begin with step 402, which may involve having a patient visit with a physician for a medical examination. Upon examining the patient, the method 400 may include having the physician prescribe a medication for the patient at step 404. Once the medication is prescribed, the physician may give the patient a card 102 that may be utilized with the system 100 at step 406. The card 102 may include, but is not limited to including a patient identification number, a financial identification number, and a group identification number. Such numbers may be assigned or generated by the system 100 for the patient. Once the card 102 is given to the patient, the method 400 may include, at step 408, electronically transmitting an electronic/digital prescription (e-prescription) to at least one of a pharmacy, wholesaler, or a manufacturer that may provide the medication to the patient.

At step 410, the method 400 may include having the patient bring the card 102 to the pharmacy to fill the prescription. Once the pharmacist gets the card 102 of the patient, the pharmacist can verify the card 102 against the e-prescription the physician provided to the pharmacy at step 412. In an embodiment, if the pharmacist verifies the card 102 against the e-prescription, the manufacturer may provide the medication to a wholesaler at step 414. At step 416, the wholesaler may provide the medication to the pharmacy for distribution to the patient. At step 418, the information related to the verification process, the prescription and/or any other information that traverses the system 100 may be recorded in the system 100 at step 418. Assuming the patient has been verified against the e-prescription, the method 400 may include generating an authorization number to allow for third party billing at step 420. Once the authorization number is generated, the method 400 may include providing the medication to the patient at step 422. At step 426, the patient may receive the medication. If, however, the patient has not been verified against the e-prescription, the method may include not providing the medication to the patient at step 424. In an embodiment, the method 400 may also include determining if multiple attempts have been made to obtain medication associated with the prescription and if the attempts are fraudulent. In another embodiment, the method 400 may include reporting potential fraudulent activity to various government agencies.

Notably, the method 400 may incorporate any of the functionality, components, or features described for the various systems, features, and methods described herein and is not intended to be limited to the description above.

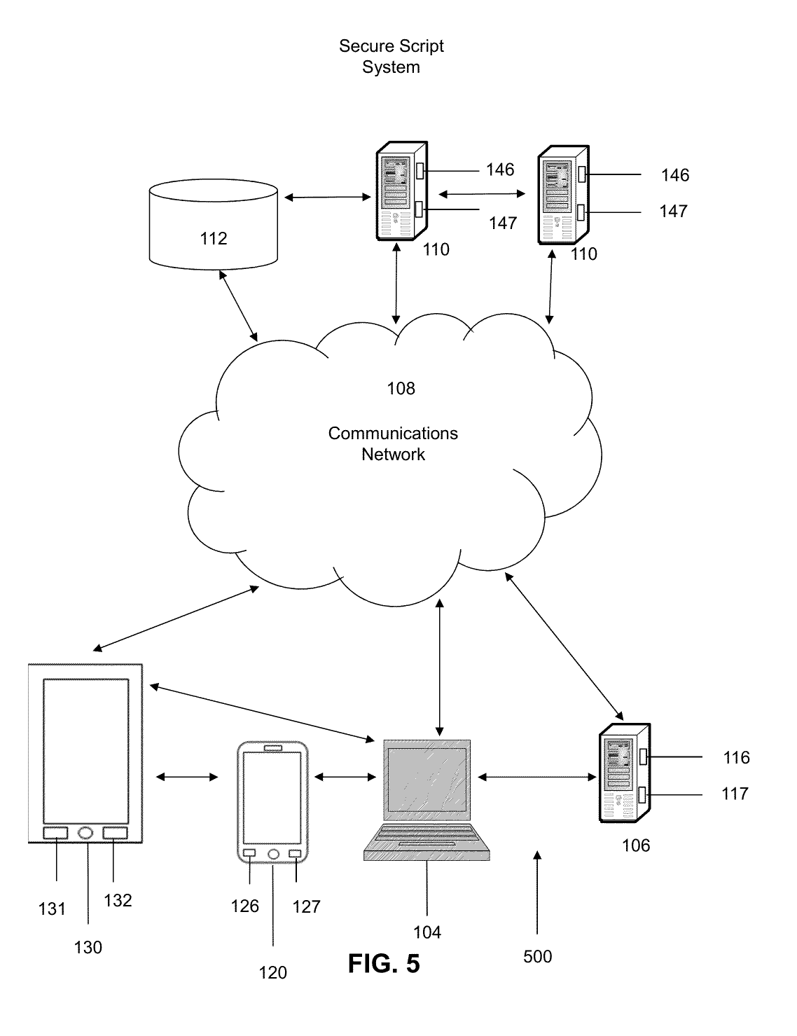

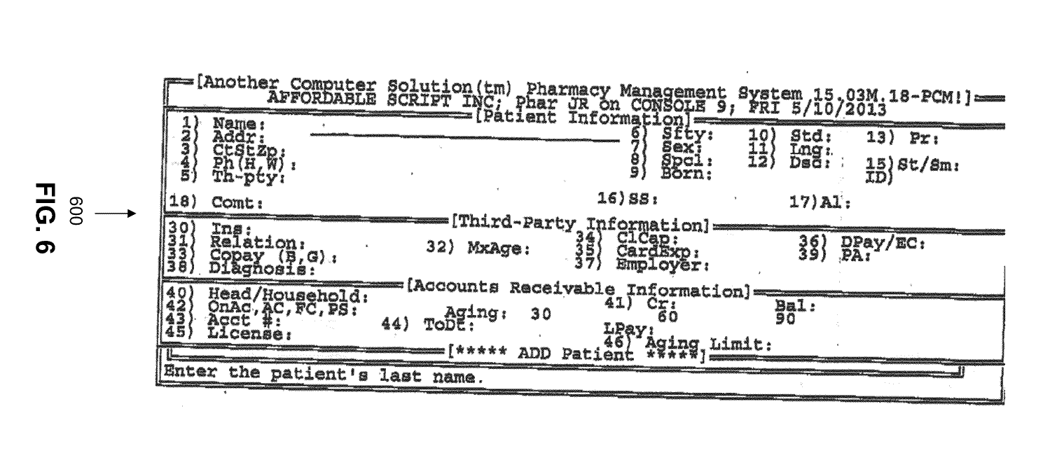

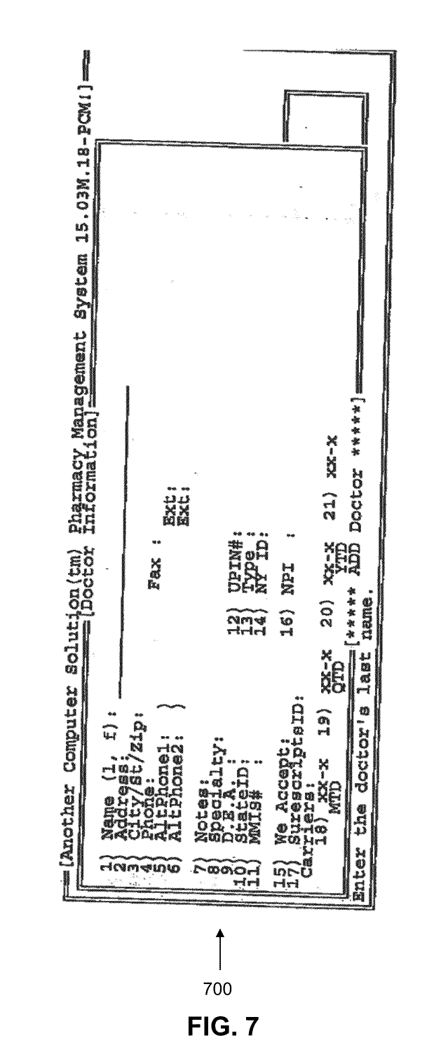

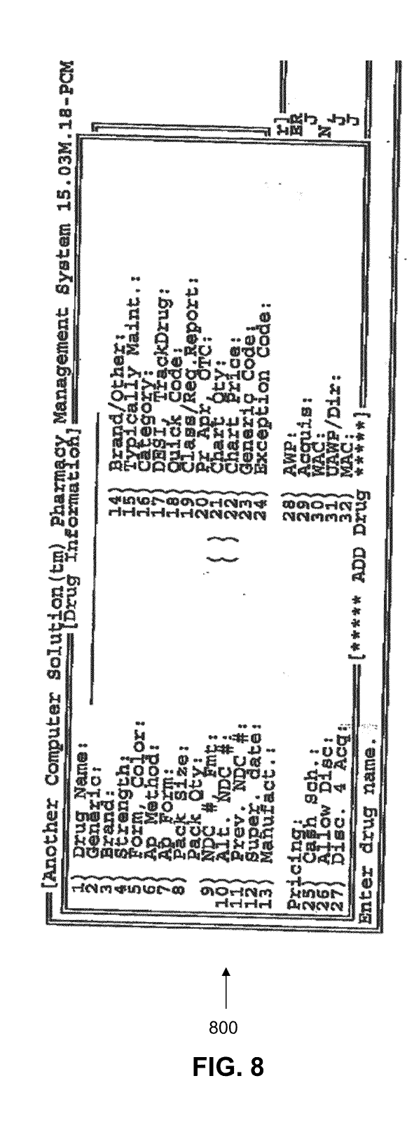

Referring to FIG. 5, an embodiment of a system 500 for prevention of fraud, which does not need the secure card 102 from system 100, is schematically illustrated. The system 500 may include the computing device 104, the server 106, the communications network 108, the servers 110, the database 112, a patient device 120, and a physician device 130. The system 500 is illustratively shown to have a particular structure, however, other alternative structures, such as those described herein or otherwise, may also be utilized. Additionally, the system 500 may include each of the components described herein or a greater or fewer number of components and is not intended to be limited to the structure illustratively shown in FIG. 5. In one embodiment, the computing device 104, the server 106, the communications network 108, the servers 110, and the database 112 may include similar components and have similar functionality to the devices found in FIG. 1.

In certain embodiments, the patient device 120 may be a smartphone, a personal digital assistant, a mobile device, a computer tablet, a computer, a laptop, a server, or any other computing device. Illustratively, the patient device 120 is shown as a smartphone in FIG. 5. Additionally, the patient device 120 may include a memory 126 that stores instructions and a processor 127 that executes the instructions from memory 126 to perform various operations for the patient device 120. In certain embodiments, the physician device 130 may be a smartphone, a personal digital assistant, a mobile device, a computer tablet, a computer, a laptop, a server, or any other computing device. Illustratively, the physician device 130 is shown as a computer tablet. Additionally, the physician device 130 may include a memory 131 that stores instructions and a processor 132 that executes the instructions from the memory 131 to perform various operations for the physician device 130. The communications network 108 may be utilized to communicatively link each of the devices in the system 500 to each other.

Operatively, the system 500 for preventing fraud may operate as follows: A patient may visit a physician for a medical examination, and the physician may determine that the patient needs a prescription for a medication to treat a condition that the physician has diagnosed. At this point, the physician and/or office personnel may register the patient with the system 500, such as via a graphical user interface of a website or other software application of the system 500. In order to register the patient with the system 500, the patient, the physician, or authorized office personnel can enter information associated with the patient into the website of the system 500, such as by using physician device 130. In a preferred embodiment, the physician or the office personnel may register the patient using physician device 130. The information associated with the patient may be entered into the system 500 via a digital form, such as form 600. In certain embodiments, the information associated with the patient may include, but is not limited to, a patient identification number, a patient name, a patient address, a patient telephone number, a patient gender, a patient date of birth, the last several digits of the patient's social security number, the patient's insurance provider, third party information, the financial identification number, the group identification number, a patient diagnosis, the patient's prescription, and various guidelines for using the prescription and the system 500. The information associated with the patient may also include any of the information displayed in form 600.

Once the information associated with the patient is submitted into the system 500, the patient may be registered with the system 500. In one embodiment, physicians, office personnel, and pharmacies that are registered with the system 500 may access some or all of the information associated with the patient. For example, in one embodiment, the physicians, office personnel, and pharmacies registered with the system 500 may only be able to view the patient identification number, the drug prescribed to the patient, the quantity of the drug to be prescribed, the name of the physician that prescribed the medication, and the date the prescription was made. All other patient information may be kept confidential within the system 500. The physician may register with the system 500 via the website or other software application of the system 500, preferably before the patient is registered with the system 500. In order to do so, the physician may access the website of the system 500 and create an account with the system 500. The website may prompt the physician to create a username and password associated with the account. The username may be a drug enforcement agency number, a self-created username, an automatically generated username, or other identifier.

Once the physician creates the username and password, the physician may be prompted by the website of the system 500 to complete an online application or form and submit the application or form to the system 500. In one embodiment, the online application or form may be digital form 700. The information that the physician submits with the application or form may include, but is not limited to, the physician's name, the physician's address, the physician's telephone and fax numbers, the physician's medical specialty, a drug enforcement agency number or other similar number, a state identification number a Medicaid Management Information System (MMIS) number, and a National Provider Identifier (NPI) Number. Additionally, the application or form may include any of the information as provided in digital form 700. Once the information from the application or form is submitted into the system 500 by the physician, such as via physician device 130, the physician's account will be activated with the system 500 once the account is approved by the system 500 or approved by authorized personnel that manage the system 500. In one embodiment, the physician must activate his or her account with the system 500 before the physician can prescribe medication through the system 500. In one embodiment, the physician account may be activated annually if physicians are required to renew their registration on an annual basis. The system 500 may transmit a signal alerting the physician of an expiration date for the account, and may prompt the physician to reactivate the account before the expiration date in order to remain registered with the system 500, such as via the website of the system 500. The signal alerting the physician of the expiration date and the prompt to reactivate may be provided by the website or other software application of the system 500. In one embodiment, the physician may reactivate, deactivate, or activate the physician account at any time.

Upon activation of the physician account by the system 500, the physician may select certain office personnel to have access to the physician's account. In order to do so, the physician may submit a formal written request to the personnel managing the system 500, or submit an electronic request through the website or other software application of the system 500. The request may include the names, employment information, and contact information for each office personnel that the physician wants to access the physician's account on the physician's behalf. If the system 500 or authorized personnel that manage the system 500 authorize the request, the selected office personnel will be allowed to generate a username and password for accessing the system 500 or the system 500 may auto-generate a username and password for each selected office personnel. The selected office personnel and the physician may be allowed to register the patients with the system 500 and maintain the patients' information in the system 500. In one embodiment, the physicians may be responsible for all information entered and all activities performed in the system 500 by their selected office personnel.

When the physician has examined the patient and made a diagnosis for the patient, the physician may input the prescription details for the patient into the system 500 via the website or other software application of the system 500. The information associated with the prescription may be input into a form, such as digital form 800. The prescription details may include, but are not limited to, the drug name, the patient name, the drug quantity, specific guidelines for using the drug, drug brand, drug strength, national drug code (NDC) information, manufacturer information, pricing information, other information provided in digital from 800, and other prescription information. The physician may input this information using physician device 130, and the information may be transmitted to computing device 104, which may be associated with a pharmacy that is registered with the system 500. Much like the registrations for the physicians and patients, a pharmacy may also register with the system 500 in a similar fashion. In order to register with the system 500, the pharmacy may access the website or other software application of the system 500 by utilizing computing device 104 and/or server 106, and create a username (e.g. drug enforcement agency number, self-generated username, or auto-generated username) and a password for creating a pharmacy account with the system 500.

Once the pharmacy creates the username and password, the pharmacy may complete an application or form and submit the application or form to the system 500. The application or form may require, but is not limited to including, the pharmacy name, the pharmacy address, the pharmacy telephone and fax numbers, the states in which the pharmacy operates, whether the pharmacy is a chain or independent pharmacy, a drug enforcement agency number, a state license number for the pharmacy, a national provider identifier (NPI) number, and information regarding each pharmacist that is employed by the pharmacy. If the system 500 approves the application or form with the pharmacy information or authorized personnel of the system 500 approve the application or form, then the pharmacy account may be activated. Each pharmacist of the approved pharmacy may be provided with individual usernames and passwords to access the system 500. Additionally, the pharmacists may be provided with risk management authorization (RMA) numbers, which may be directly noted on each prescription that a pharmacist of the approved pharmacy fills for a patient. In one embodiment, only pharmacies that are registered with the system 500 may be authorized to receive prescriptions from physicians. In one embodiment, the pharmacy account may be activated annually if the pharmacists are required by the system 500 to renew their registration on an annual basis. The system 500 may transmit a signal alerting the pharmacy of an expiration date for the pharmacy account, and may prompt the pharmacy to reactivate the account before the expiration date in order to remain registered with the system 500. The signal alerting the pharmacy of the expiration date and the prompt to reactivate may be provided by the website or other software application of the system 500. In one embodiment, the pharmacy may reactivate, deactivate, or activate the pharmacy account at any time.

The prescription and accompanying information that is sent to the computing device 104 may be viewed by an authorized pharmacist of the approved pharmacy by using the pharmacy account. In one embodiment, the pharmacist may view the prescription and accompanying information via a graphical user interface of the website or other software application of the system 500 that is displayed on computing device 104. The pharmacist may obtain the medicine associated with the prescription from wholesalers, which, in turn, may obtain the medication associated with the prescription from drug manufacturers. In one embodiment, a wholesaler may also register with the system 500. In order to register with the system 500, the wholesaler may access the website or other software application of the system 500. The wholesaler may create a username (e.g. drug enforcement agency number, self-generated username, or auto-generated username) and password to create a wholesaler account with the system. Once the username and password are created for the wholesaler, the wholesaler may complete an online application or form, and submit the application or form to the system 500 for processing. The online application or form may include, but is not limited to, the wholesaler name, the wholesaler address, the wholesaler telephone and fax numbers, a drug enforcement agency number, a state license number, National Drug Code (NDC) numbers for the drugs the wholesaler carries, information regarding the pharmacies to which the wholesaler delivers drugs to, and information for the manufacturers that produce the drugs that the wholesaler distributes. In one embodiment, the pharmacies that are delivered drugs by the wholesaler must be registered with the system 500. The wholesaler account may be activated once the application or form is approved by the system 500 or approved by authorized personnel of the system 500. In one embodiment, the wholesaler account may be activated annually if the wholesaler is required by the system 500 to renew their registration on an annual basis. The system 500 may transmit a signal alerting the wholesaler of an expiration date for the wholesaler account, and may prompt the wholesaler to reactivate the account before the expiration date in order to remain registered with the system 500. The signal alerting the wholesaler of the expiration date and the prompt to reactivate may be provided by the website or other software application of the system 500. In one embodiment, the wholesaler may reactivate, deactivate, or activate the wholesaler account at any time.

Drug manufacturers may also register with the system 500. The manufacturers may access the website or other software application of the system 500 to register with the system 500. The manufacturer may create a username (e.g. drug enforcement agency number, self-generated username, or auto-generated username) and password to create a manufacturer account with the system. Once the username and password are created for the manufacturer, the manufacturer may complete an online application or form, and submit the application or form to the system 500 for processing. The application or form may include, but is not limited to, the manufacturer name, the manufacturer address, the manufacturer telephone and fax numbers, a drug enforcement agency number, a state license number, National Drug Code (NDC) numbers for the drugs the manufacturer makes, information for the wholesalers that the manufacturers deliver drugs to, and package sizes for the drugs that the manufacturer makes. The manufacturer account may be activated once the application or form is approved by the system 500 or approved by authorized personnel of the system 500. In one embodiment, the manufacturer account may be activated annually if the wholesaler is required by the system 500 to renew their registration on an annual basis. The system 500 may transmit a signal alerting the manufacturer of an expiration date for the manufacturer account, and may prompt the manufacturer to reactivate the account before the expiration date in order to remain registered with the system 500. The signal alerting the manufacturer of the expiration date and the prompt to reactivate may be provided by the website or other software application of the system 500. In one embodiment, the manufacturer may reactivate, deactivate, or activate the manufacturer account at any time.

Once the prescription has been sent to the pharmacy, the patient may attempt to fill the prescription at the pharmacy. The patient may present the pharmacist with a written prescription that is prepared by the physician or show a digital prescription (e.g. e-prescription) to the pharmacist on a display of patient device 120. The written prescription and/or digital prescription may include, but is not limited to, the patient identifier, the patient name, prescription information and dosage, the physician name, selected information from the patient form 700, selected information from physician form 800, selected information from drug form 900, and other desired information. All information associated with the patient, the physician, office personnel, pharmacies, wholesalers, manufacturers, the prescription, and the information exchanges occurring between all of the devices in the system 500 may be stored in the database 112 and/or transmitted to all devices and entities in the system 500. In an embodiment, if the information provided in the written prescription or digital prescription does not match the information provided in the prescription that the physician sent to the pharmacy, the patient may have attempted to commit prescription fraud. In one embodiment, the computing device 104, the server 106, the servers 110, and the database 112 may be utilized to determine if the written prescription or digital prescription matches the information provided in the prescription that the physician transmitted to the pharmacy. If the patient attempted to commit prescription fraud, such as if the information does not match, the system 500 may generate a report and send the report to a government agency to investigate the matter further. In another embodiment, if the information in the written or digital prescription does match the information in the prescription sent from the physician to the pharmacy, the computing device 104 or other device in the system 500 may transmit a signal to wholesalers and manufacturers to supply the pharmacy with medication to distribute to the patient. In yet another embodiment, if the patient is verified to receive the medication, the system 500 may generate an authorization number to allow for third party billing, and then the medication may be given to the patient.

In one embodiment, the system 500 may also generate a quick response code, a digital bar code, a digital card, or other similar type of digital storage code or medium that includes the information associated with the patient, along with the prescription. In one embodiment, the code may be sent to the patient device 120 by the system 500 so that when a patient attempts to fill the prescription, the patient may present the code to the pharmacist on the display of the patient device 120. The pharmacist may scan the code using a digital code reader (e.g. bar code scanner or other similar device) or manually input the code to confirm that the information in the digital code matches the information provided in the prescription that was sent to the pharmacy by the physician. If the information in the digital code matches the information provided by the physician in the prescription, then the patient may be authorized to receive the medication associated with the prescription. If, however, the information in the digital code does not match the information provided by the physician in the prescription, then the system 500 may generate an alert and prevent the patient from receiving the medication In one embodiment, only entities that are registered with the system and have accounts with the system may be able to view any of the information traversing the system. Notably, the system 500 may incorporate any of the functionality, features, devices, and information from system 100, and the system 100 may incorporate any of the functionality, features, devices, and information from system 500.

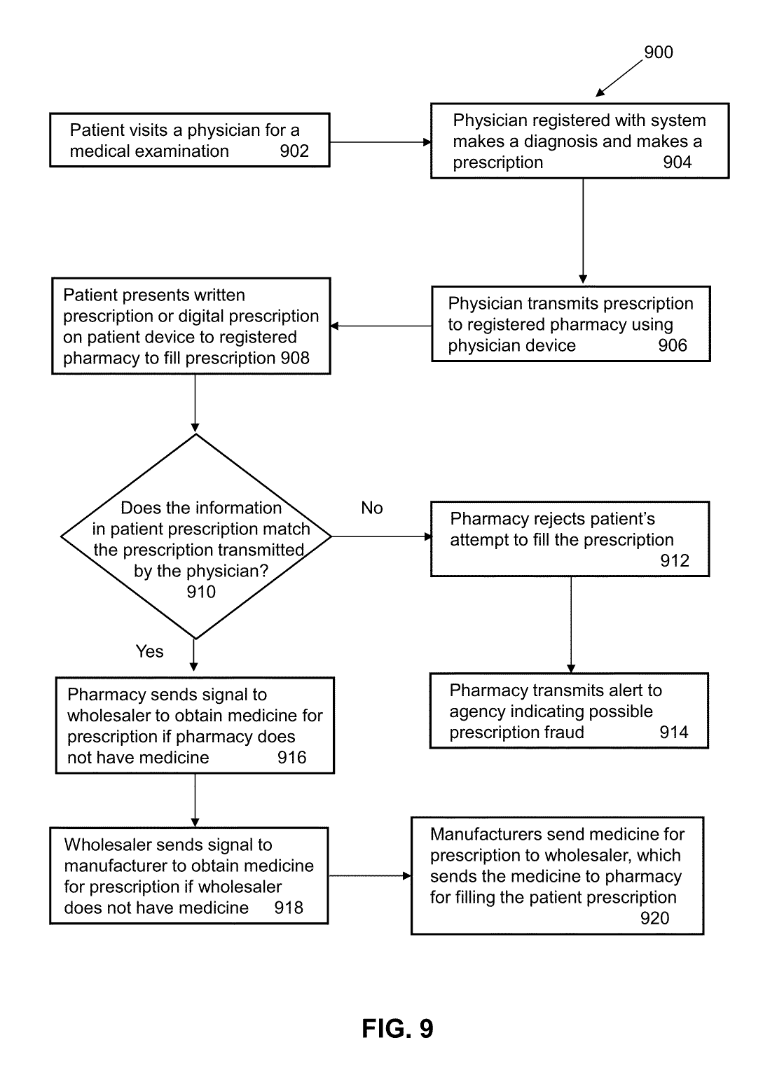

As shown in FIG. 9, an exemplary method 900 for preventing fraud is schematically illustrated. The method 900 may include, at step 902, having a patient visit a physician for a scheduled medical examination. At step 904, the method 900 may include having a physician registered with either system 100 or 500 make a diagnosis and make a prescription for the patient based on the diagnosis. In one embodiment, the physician may input information associated with the prescription, such as dosage, quantity, drug name, drug type, patient name, and other information as disclosed herein into the website or other software application of the system 100. At step 906, the method 900 may include transmitting the prescription to a pharmacy registered with the system 100 or 500. In one embodiment, the prescription may be transmitted from physician device 130 to computing device 104 and server 106, which may be associated with the pharmacy. The method 900 may include, at step 908, having the patient present a written prescription or a digital prescription to a pharmacist of the registered pharmacy to fill the prescription. In one embodiment, the digital prescription may be presented on the patient device 120 to the pharmacist.

At step 910, the method 900 may include determining if the information in the written or digital prescription provided by the patient matches the information provided in the prescription sent by the physician. This determination may be performed by any of the devices in the system 500. If the information in the written or digital prescription provided by the patient does not match the information provided in the prescription sent by the physician, the method 900 may include rejecting the patient's attempt to fill the prescription at step 912. In one embodiment, the system 100 or 500 may display the rejection on the computing device 104 so that the pharmacist can inform the patient that the prescription is unauthorized. At step 914, the method 900 may include transmitting a signal to a drug enforcement agency or other similar agency indicating that possible prescription fraud may be been perpetrated by the patient. The signal may include information associated with the patient and information associated with the prescription that the patient was attempting to fill. In one embodiment, the signal may be transmitted by the computing device 104 and/or server 106 to a device of the agency.

If, however, the information in the written or digital prescription provided by the patient does match the information provided in the prescription sent by the physician, the method 900 may include, at step 916, sending a signal to a computing device of a wholesaler to obtain the medicine for the prescription if the pharmacy does not already have the medicine. The signal may include all information associated with the prescription. In one embodiment, if the pharmacy already does have the medicine in stock, the pharmacist can dispense the medication and provide it to the patient. If the medicine is not already at the pharmacy, the signal may be processed by the wholesaler to obtain the medicine for the prescription. If the wholesaler has the medicine already, the wholesaler can send the medicine to the pharmacy, which can fulfill the patient's prescription. However, if the wholesaler does not have the medicine in stock, the method 900 may include, at step 918, having the wholesaler transmit a signal to a computing device of the manufacturer of the medicine to obtain the medicine for the prescription. At step 920, the manufacturer can send the medicine for the prescription to the wholesaler, which can send the medicine to the pharmacy so that the pharmacy can fulfill the prescription. Notably, method 900 may incorporate any of the functionality described herein for the systems and methods presented herein.

In one embodiment, the system 100, the system 500, and methods described herein may further include utilizing any of the various components described in the system 100 and system 500 to perform any of the operative functions disclosed herein. Furthermore, it is important to note that the methods described above may incorporate any of the functionality, devices, and/or features of the system 100, system 500, and subsystems described above, or otherwise, and are not intended to be limited to the description or examples provided herein.

Upon reviewing the aforementioned embodiments, it would be evident to an artisan with ordinary skill in the art that said embodiments can be modified, reduced, or enhanced without departing from the scope and spirit of the claims described below.

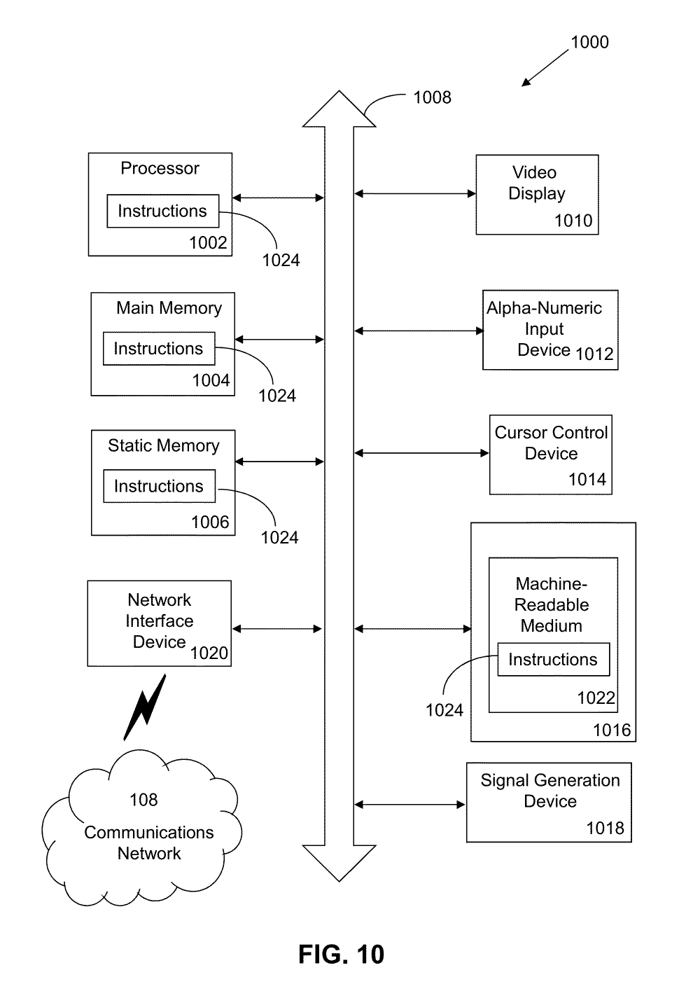

Referring now also to FIG. 10, at least a portion of the methodologies and techniques described with respect to the exemplary embodiments of the system 100 and/or system 500 can incorporate a machine, such as, but not limited to, computer system 1000, or other computing device within which a set of instructions, when executed, may cause the machine to perform any one or more of the methodologies or functions discussed above. The machine may be configured to facilitate various operations conducted by the system 100 and system 500. For example, the machine may be configured to, but is not limited to, assist the system 100 and system 500 by providing processing power to assist with processing loads experienced in the system 100 and system 500, by providing storage capacity for storing instructions or data traversing the system 100 and system 500, or by assisting with any other operations conducted by or within the system 100 and system 500.

In some embodiments, the machine operates as a standalone device. In some embodiments, the machine may be connected (e.g., using communications network 108) to and assist with operations performed by other machines, such as, but not limited to, the servers 110, the server 106, the computing device 104, the physician device 130, the patient device 120, the database 112, other devices in the system 100 or system 500, or any combination thereof. The machine may be connected with any component in the system 100. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 1000 may include a processor 1002 (e.g., a central processing unit (CPU), a graphics processing unit (GPU, or both), a main memory 1004 and a static memory 1006, which communicate with each other via a bus 1008. The computer system 1000 may further include a video display unit 1010 (e.g., a liquid crystal display (LCD), a flat panel, a solid state display, or a cathode ray tube (CRT)). The computer system 1000 may include an input device 1012 (e.g., a keyboard), a cursor control device 1014 (e.g., a mouse), a disk drive unit 1016, a signal generation device 1018 (e.g., a speaker or remote control) and a network interface device 1020.

The disk drive unit 1016 may include a machine-readable medium, computer-readable device, or machine-readable device 1022 on which is stored one or more sets of instructions 1024 (e.g., software) embodying any one or more of the methodologies or functions described herein, including those methods illustrated above. The instructions 1024 may also reside, completely or at least partially, within the main memory 1004, the static memory 1006, or within the processor 1002, or a combination thereof, during execution thereof by the computer system 1000. The main memory 1004 and the processor 1002 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium, computer-readable device, or machine-readable or device 1022 containing instructions 1024 so that a device connected to the communications network 108 can send or receive voice, video or data, and to communicate over the communications network 108 using the instructions. The instructions 1024 may further be transmitted or received over the communications network 108, via the network interface device 1020.

While the machine-readable medium or device 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium or device that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure not be limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A system for preventing fraud comprising:
a memory that stores instructions;
a processor that executes the instructions to perform operations, the operations comprising:
receiving a prescription for a patient from a physician registered with the system, wherein the prescription includes a first patient identification number, a first financial identification number, and a first group identification number of a patient associated with the prescription;
receiving a second patient identification number, a second financial identification number, and a second group identification number from a digital prescription of the patient when the patient attempts to fill the prescription; and
allowing medicine associated with the prescription to be given to the patient if the first the first patient identification number, the first financial identification number, and the first group identification number of the prescription match the second patient identification number, the second financial identification number, and the second group identification number from the digital prescription of the patient.

2. The system of claim 1, wherein the operations further comprise assigning the first patient identification number, the first financial identification number, and the first group identification number to the digital prescription of the patient.

3. The system of claim 1, wherein the operations further comprise storing at least one of the prescription, information associated with the digital prescription, and information associated with matching the prescription with the digital prescription of the patient.

4. The system of claim 1, wherein the operations further comprise generating an authorization number to allow for third party billing when the first patient identification number, the first financial identification number, and the first group identification number of the prescription match the second patient identification number, the second financial identification number, and the second group identification number from the digital prescription of the patient.

5. The system of claim 1, wherein the operations further comprising providing a rejection to the patient if the patient attempts to use the digital prescription to fill the prescription at an interval not provided for in the prescription.

6. The system of claim 1, wherein the operations further comprise registering at least one of the physician, the patient, a wholesale, an institution, a manufacturer, and a pharmacy with the system.

7. The system of claim 1, wherein the operations further comprise transmitting a report to a government agency, wherein the report includes at least one of the prescription, information associated with the digital prescription, information associated with matching the prescription with the digital prescription of the patient, and other information generated by the system.

8. The system of claim 1, wherein the operations further comprise transmitting a fraud alert if the first patient identification number, the first financial identification number, and the first group identification number of the prescription do not match the second patient identification number, the second financial identification number, and the second group identification number from the digital prescription of the patient.

9. The system of claim 1, wherein the prescription for the patient from the physician includes at least one of a name of the patient, an address of the patient, a date of birth of the patient, a date associated with the prescription, a name of the physician, a drug enforcement agency number, a national provider identifier number, and a dosage of the medicine.

10. The system of claim 1, wherein at least one of the prescription, information associated with the patient, the first patient identification number, the first financial identification number, and the first group identification number are stored with the digital prescription.

11. A method for preventing fraud comprising:
receiving a prescription for a patient from an authorized physician, wherein the prescription is received by a processor of a system;
receiving a patient identification number, a financial identification number, and a group identification number from a digital prescription of the patient when the patient attempts to fill the prescription;
determining if the patient identification number, the financial identification number, and the group identification number from the digital prescription match the prescription received for the patient by utilizing the processor of the system; and
transmitting a signal to allow the patient to receive medicine associated with the prescription if the patient identification number, the financial identification number, and the group identification number from the digital prescription are determined to match the prescription for the patient from the authorized physician.

12. The method of claim 11, further comprising transmitting a signal to prevent the patient from receiving the medicine associated with the prescription if the patient identification number, the financial identification number, and the group identification number from the digital prescription are determined to not match the prescription for the patient from the authorized physician.

13. The method of claim 11, further comprising transmitting a signal to prevent the patient from receiving the medicine if the patient attempts to use the digital prescription to fill the prescription at an interval not provided for in the prescription for the patient from the authorized physician.

14. The method of claim 11, further comprising registering at least one of the physician, the patient, a wholesaler, an institution, a manufacturer, and a pharmacy with the system.

15. The method of claim 11, further comprising generating an authorization number to allow for third party billing when the patient identification number, the financial identification number, and the group identification number of the prescription match the prescription for the patient from the authorized physician.

16. The method of claim 11, further comprising storing the prescription, information associated with the digital prescription, and information associated with matching the prescription with the digital prescription of the patient.

17. The method of claim 11, further comprising transmitting a report to a government agency if the patient identification number, the financial identification number, and the group identification number from the digital prescription are determined to not match the prescription for the patient from the authorized physician.

18. A system for preventing fraud comprising:
a memory that stores instructions;
a processor that executes the instructions to perform operations, the operations comprising:
receiving a prescription for a patient from a physician registered with the system;
receiving a patient identification number, a financial identification number, and a group identification number from a digital prescription of the patient when the patient attempts to fill the prescription;
determining if the patient identification number, the financial identification number, and the group identification number from the digital prescription match the prescription received for the patient from the physician; and
transmitting a signal to enable the patient to receive medicine associated with the prescription if the patient identification number, the financial identification number, and the group identification number from the digital prescription are determined to match the prescription for the patient from the physician.

19. The system of claim 18, wherein the operations further comprise transmitting a signal to prevent the patient from receiving the medicine associated with the prescription if the patient identification number, the financial identification number, and the group identification number from the digital prescription do not match the prescription for the patient from the physician.

20. The system of claim 18, wherein the operations further comprise transmitting a signal to prevent the patient from receiving the medicine if the patient attempts to use the digital prescription to fill the prescription at an interval not provided for in the prescription for the patient from the physician.
